(19) United States
(12) Patent Application Publication
(10) Pub. No.: US 2008/0117328 A1
(43) Pub. Date: May 22, 2008

(54) Retractable camera arm

(76) Inventors: Michael Daoud, Goleta, CA (US); John R. Stump, Santa Barbara, CA (US)

Correspondence Address: KOPPEL, PATRICK & HEYBL, 555 ST. CHARLES DRIVE, SUITE 107, THOUSAND OAKS, CA, 91360, US

(21) Appl. No.: 11/604,466

(22) Filed: Nov. 21, 2006

(51) Int. Cl. H04N 5/225

(52) U.S. Cl. 348/373

(57) ABSTRACT

An apparatus that aids in the taking of self-portraits comprising an imaging device such as a camera or video-camera, a retractable arm having a first end and a second end, an optional grip handle surrounding the first end of the retractable arm, a platform on the second end of the retractable arm that releasably secures the imaging device, and an optional remote switch to activate the imaging device. The retractable arm telescopically expands and retracts and can be made of a light, thin-wall tubing material while the grip handle can be made of a soft rubber material.

### REFERENCE TO PRIOR APPLICATION

This application claims the priority of provisional application 60/738,515, filed Nov. 22, 2005 entitled RETRACTABLE CAMERA ARM by Michael Daoud and John Stump.

### BACKGROUND OF THE INVENTION

1. Field of the Invention

The present invention relates generally to the field of camera accessories, and particularly to an accessory that allows the user to take action shots of himself or herself or self-portraits, as well as unusual angle shots, such as overhead shots, without setting the camera on a stand that is disconnected from the person of the user or having a second party take the photograph.

2. Description of the Prior Art

Camera self-portrait devices are well-known in the art and typically involve tri-pods, mono-pods or some other variation on the idea of having the camera set at a position away from the person of the person being photographed.

The prior art in the field involves a variety of inventions that seek to support cameras to the camera man's body or to other collateral supports such as trees, fences, tripods, monopods and multi-pods. None of the prior art seeks to provide the ability to take self-portraits or group portraits when there is no third party available to snap them or no exterior object on which to mount the camera. This is particularly true for photos taken in action settings.

The traditional methods of self-portrait aids suffer in their requirement for legs and/other mounting devices to hold the camera onto an exterior object, such as a fence or a tree. Additionally, action shots cannot be taken with these types of devices as the time and effort required to set the camera in place removes the spontaneity of taking action shots as they occur. This is because the frame must be set and the shot must take place within that frame. Most action shots cannot be prearranged in such a fashion. Accordingly, there exists a need for a picture-taking device that can be activated by the person being photographed that does not need to be pre-set in order to take the shot, thereby allowing spontaneous action shots to be snapped that heretofore were impossible to achieve.

The instant invention also gives a cameraperson the ability to take odd angle shots, such as overhead shots, without the use of large, bulky equipment.

### SUMMARY OF THE INVENTION

The preferred embodiment of the present invention teaches a method and apparatus that aids in the taking of self-portraits comprising an imaging device such as a camera or video-camera, a retractable arm having a first end and a second end, and a platform on the second end of the retractable arm that releasably secures the imaging device.

It is yet another embodiment of the present invention wherein the above embodiment is further modified by defining that the retractable arm telescopically expands and retracts.

It is yet another embodiment of the present invention wherein the above embodiment is further modified by defining that the retractable arm is made of a light, thin-wall tubing material.

It is yet another embodiment of the present invention that a grip handle surrounds the first end of the retractable arm.

It is yet another embodiment of the present invention wherein the above embodiment is further modified by defining that the grip handle is made of a soft, flexible, grippable material.

It is yet another embodiment of the present invention wherein a remote switch allows activation of the imaging device.

### BRIEF DESCRIPTION OF THE DRAWINGS

FIG. 1 is a view of the device in its expanded position held by a person for a self-portrait.

FIG. 2 is view of the device in its retracted position held by a person for a self-portrait.

FIG. 3 is a close up view of the second end of the device that terminates in the platform with a photo imaging device located thereon.

FIG. 4 is a perspective view of the device in its expanded position with a photo imaging device located on the platform.

FIG. 5 is an isometric view of the device in its expanded position without a photo imaging device on the platform.

FIG. 6 is an isometric view of the device in its retracted position without a photo imaging device on the platform.

FIG. 7 is a perspective view of the device in its expanded position without a photo imaging device on the platform, but with a gripping handle attached to the retractable arm and the remote shutter activation switch present.

FIG. 8 is a close up view of the device shown along the line 8-8 in FIG. 8

FIG. 9 is a perspective view of the device in its expanded position without a photo imaging device on the platform, but with a gripping handle attached to the retractable arm and without the remote shutter activation switch present.

FIG. 10 is a perspective view of the device in its expanded position without a photo imaging device on the platform, illustrating how the gripping handle is optionally detachable from the retractable arm.

FIG. 11 is a close up view of the device shown along the line 11-11 in FIG. 10.

FIG. 12 is a close up side view of the device with the arm in its retracted position and the platform empty.

FIG. 13 is a close-up front view of the device with the arm in its retracted position and the platform empty.

FIG. 14 is a close up side view, opposite of the view shown in FIG. 12, with the arm its retracted position and the platform empty.

FIG. 15 is an exploded view of the platform portion of the device.

FIG. 16 is a close-up exploded view of the platform portion of the device with each component identified.

### DETAILED DESCRIPTION OF A PREFERRED EMBODIMENT

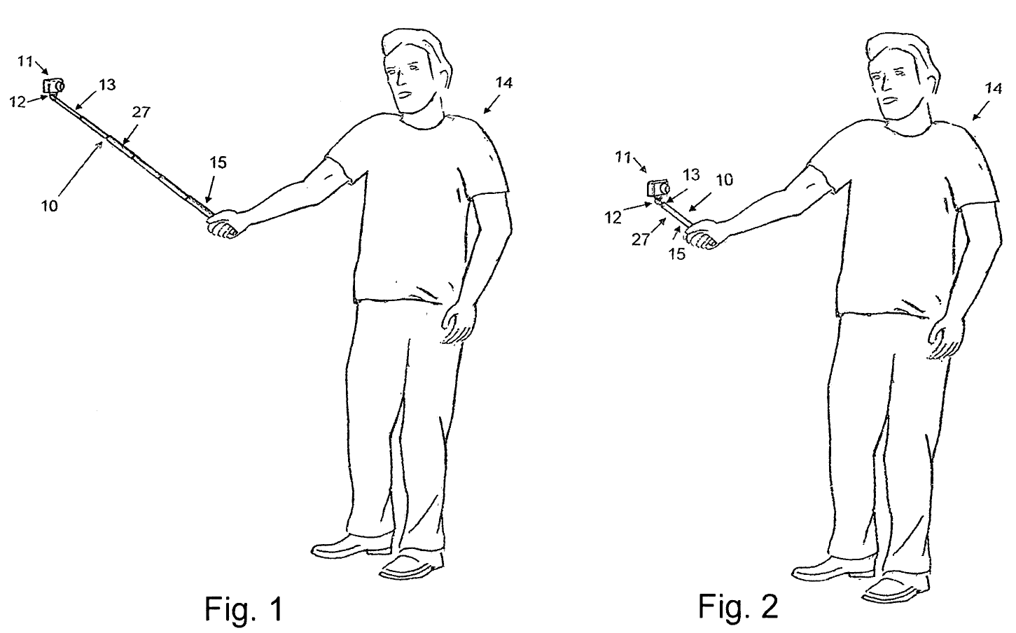

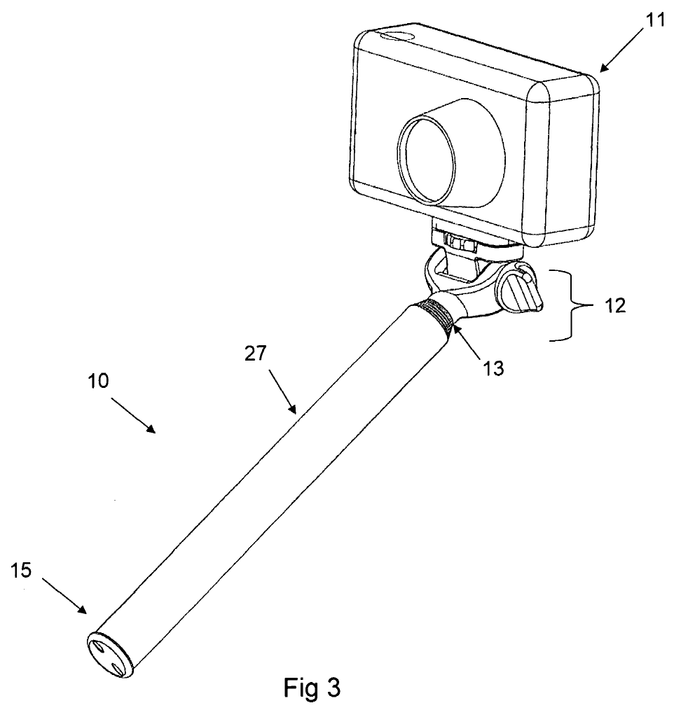

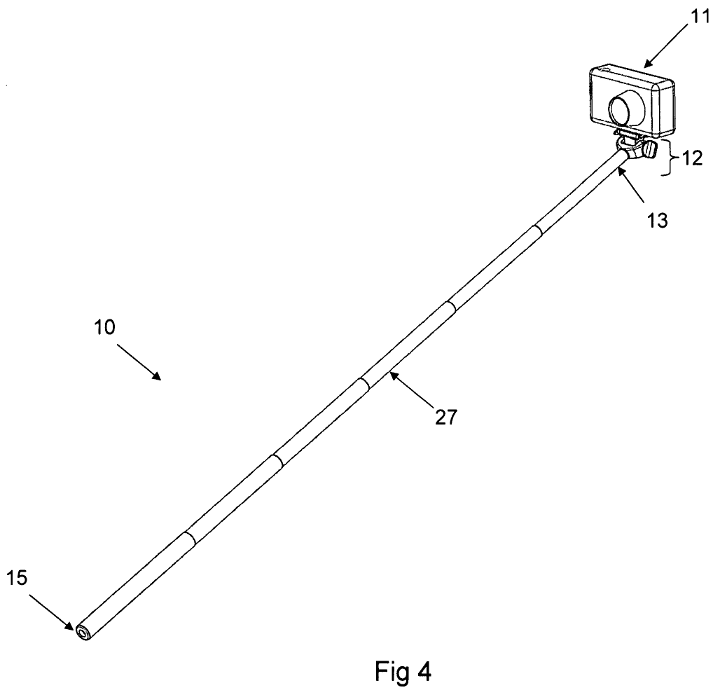

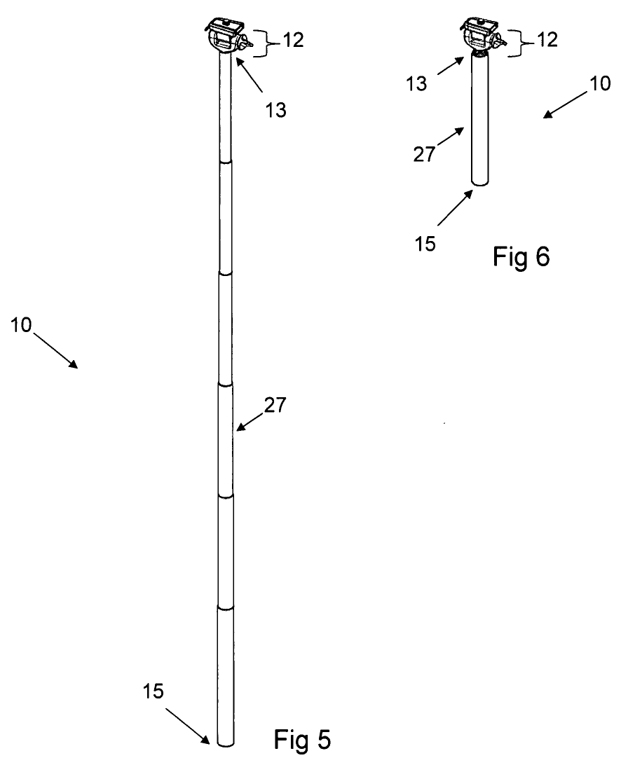

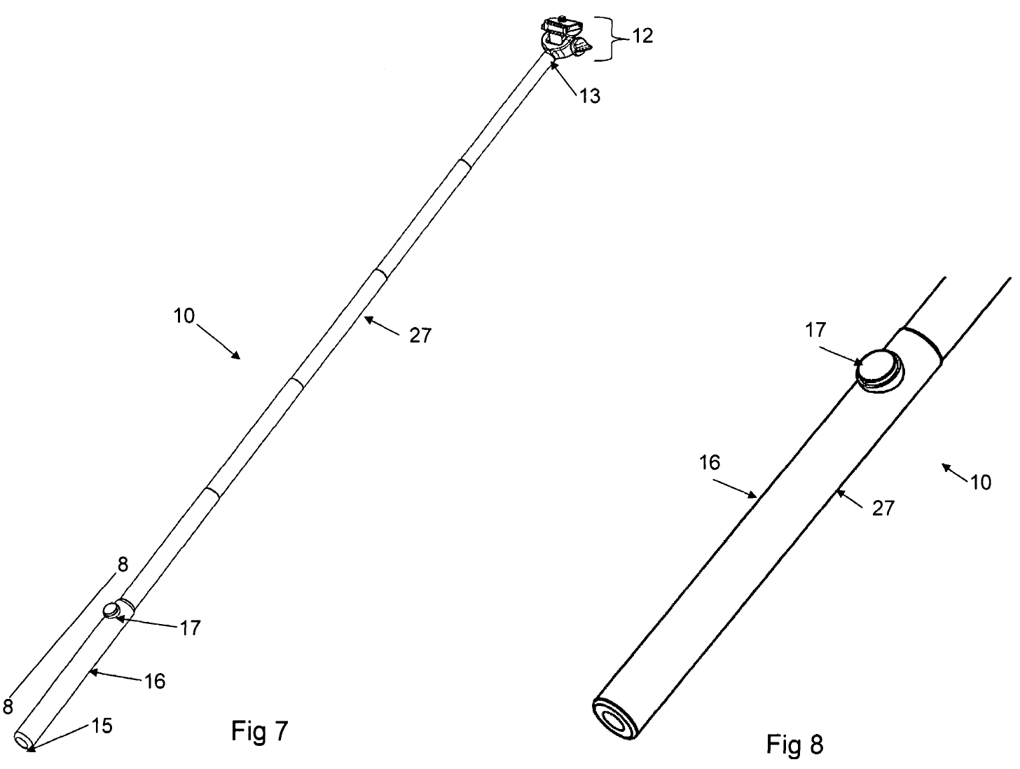

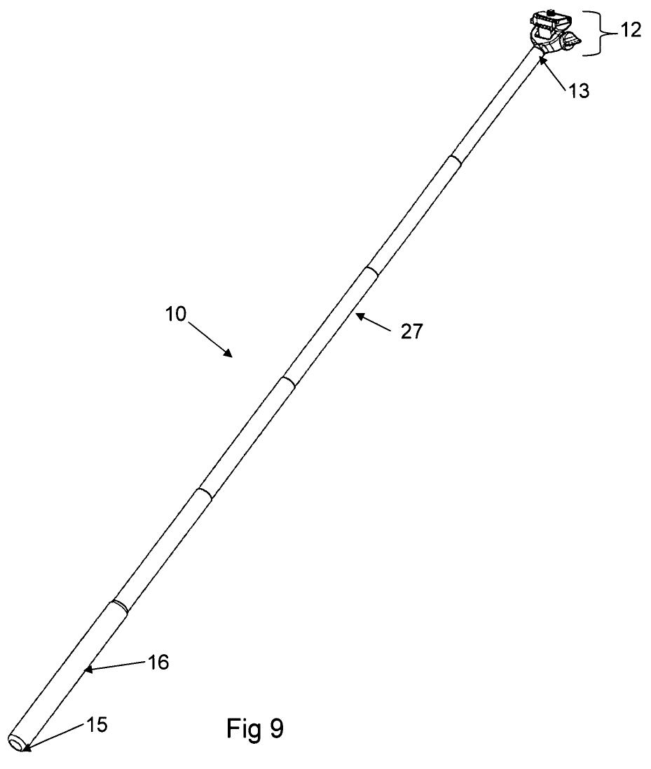

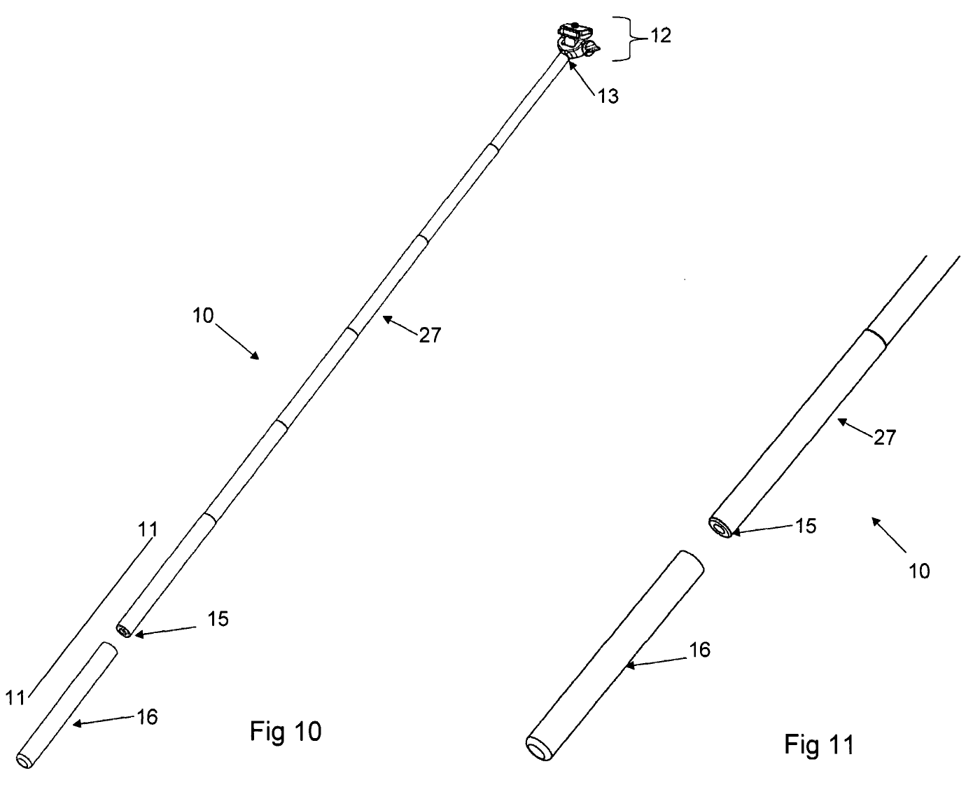

Turning to the drawings, we describe a preferred embodiment and best mode of practicing the present invention. FIGS. 1-2 show the device 10 in the hands of a user 14, both in its expanded position (FIG. 1) and in its retracted position (FIG. 2) while holding a photo imaging device 11 on the platform 12 on the second end of the device 13 while being held in the hand of the user 14 by the first end 15 for framing a shot. The remaining figures show a variety of expanded/retracted, perspective and exploded views of the device 10.

The device 10 is primarily composed of a retractable arm 27 that retracts to a short, easily transported device when not in use and expands to a telescoping position when in use for taking photographic images. The arm 27 has a first end 15 that is held in the hand of the user 14. The arm 27 has a corresponding second end 13 that terminates in a platform 12 that houses a photo imaging device 11.

Optionally, a soft, flexible gripping handle 16 can be attached to the first end 15 for a more comfortable grip. Either on the gripping handle 16 or near the first end of the arm 27 can also be a remote switch 17 that activates the shutter (not shown) on the photo imaging device 11.

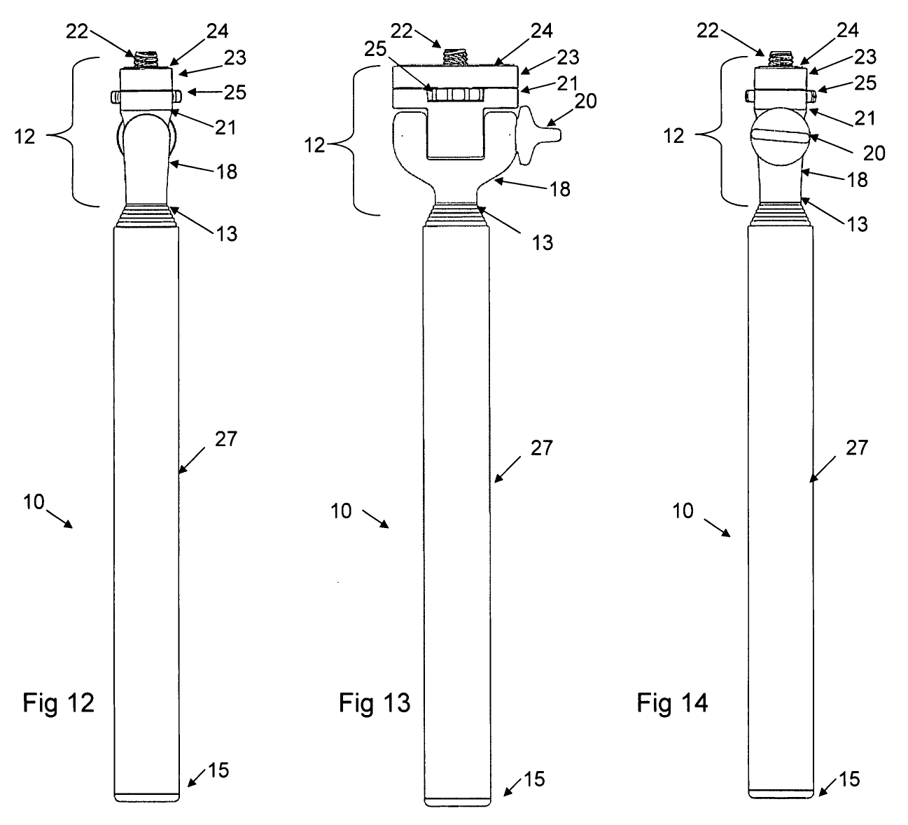

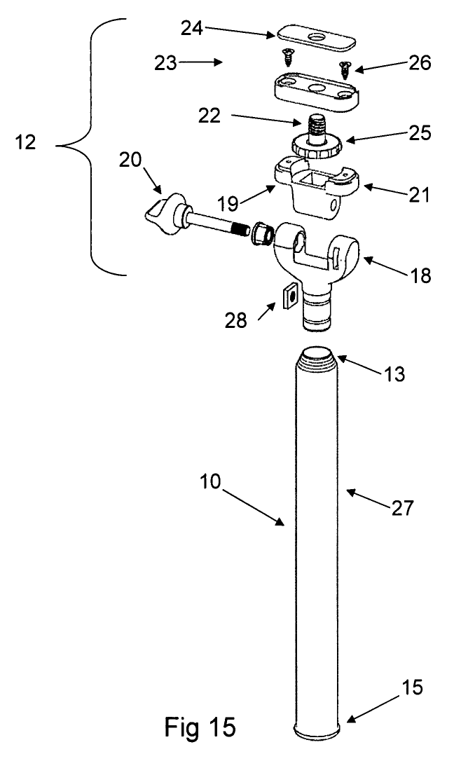

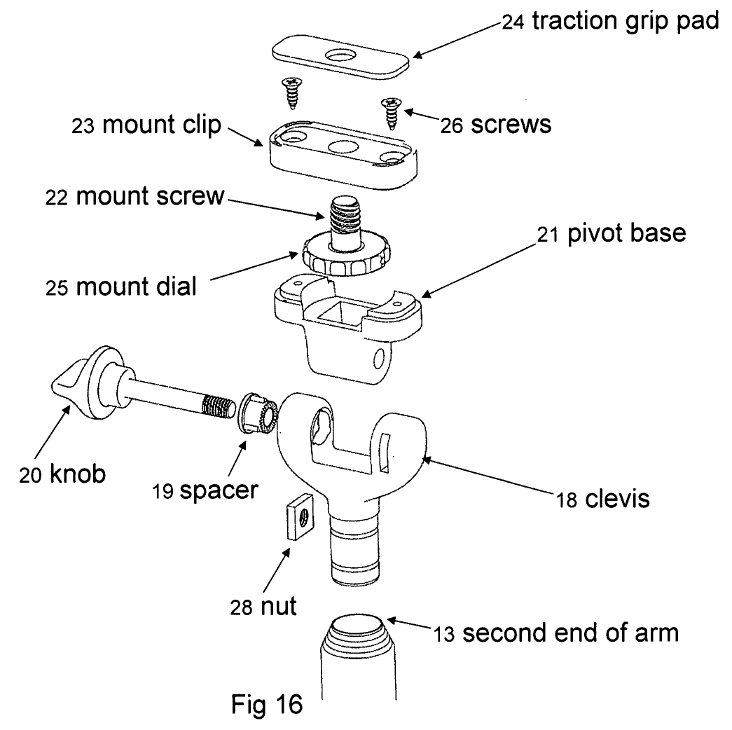

The platform 12 is further broken down into its component parts that house the photo imaging device 11 in FIGS. 12-16. These component parts include a clevis 18 that is mounted on the second end 13 of the arm 27. Into the clevis 18 sits a pivot base 21 that is held in place with a spacer 19 and a knob 20. Mounted on the pivot base 21 are a mount dial 25, mount screw 22 and mount clip 23, connected by screws 26. The traction grip pad 24 being located on the top portion of the mount clip 23.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

1. An apparatus to aid in taking a self-portrait comprising
an imaging device;
a retractable arm having a first end and a second end;
a platform on said second end of said retractable arm;
said platform releasably secured to said imaging device;
said platform including a pivot base allowing adjustment of the angle of the image device in a single plane in regard to an axis through the center of the retractable arm.

2. The apparatus according to claim 1 wherein said retractable arm is telescopically expandable and retractable.

3. The apparatus according to claim 1 wherein said retractable arm is made of a light weight, thin-walled tubing material.

4. The apparatus according to claim 1 wherein a grip handle surrounds said first end of said retractable arm.

5. The apparatus according to claim 4 wherein said grip handle is formed from a soft, flexible grippable material.

6. The apparatus according to claim 1 further comprising a remote switch for use to activate said imaging device.

7. A method for taking self-portrait images comprising
placement of and releasably securing an imaging device on a platform attached to a second end of a retractable arm, said retractable arm having a first end and a second end;
expanding said retractable arm to a position that allows for the activation of said imaging device;
activating said imaging device.

8. The method according to claim 7 wherein said retractable arm telescopically extended to position the imaging device at greater than an arms length from the self portrait subject.

9. The method according to claim 7 wherein said retractable arm is made of a light weight, thin-walled tubing material.

10. The method according to claim 7 wherein the self portrait subject holds a grip handle surrounding said first end of said retractable arm.

11. The method according to claim 10 wherein said grip handle is made of a soft, flexible, grippable material.

12. The method according to claim 7 wherein a remote switch is used for activation of said imaging device.

13. The apparatus of claim 1 wherein the imaging device is a photographic camera or video camera.
